(19) United States
(12) Patent Application Publication
(10) Pub. No.: US 2008/0028654 A1
(43) Pub. Date: Feb. 7, 2008

(54) PATIENT STATUS SYSTEM

(76) Inventors: Kerrie H.P. Cardon, Whitefish, MT (US); Stewart S. Cardon, Whitefish, MT (US)

Correspondence Address: BLACK LOWE & GRAHAM, PLLC, 701 FIFTH AVENUE, SUITE 4800, SEATTLE, WA, 98104, US

(21) Appl. No.: 11/422,859

(22) Filed: Jun. 7, 2006

Related U.S. Application Data
(60) Provisional application No. 60/688,253, filed on Jun. 7, 2005.

(51) Int. Cl. G09F 3/00

(52) U.S. Cl. 40/633

(57) ABSTRACT

An apparatus and method to augment patient identification systems includes the use of markers with colors or indicia to indicate visually a patient's medical conditions, resuscitation regimen preferences, and allergies to health care providers. The system includes color-coded or other visual devices that are affixed to the patient's identification band. The visual devices are configured to impede removal after affixing.

### PRIORITY CLAIM

This application claims priority to the provisional application of the same name with Application Ser. No. 60/688,253 filed on Jun. 7, 2005 and whose teaching is incorporated by this reference.

### FIELD OF THE INVENTION

This invention relates generally to Identification Systems and, more specifically, to patient identification bracelets.

### BACKGROUND OF THE INVENTION

Medical treatment errors arising out of drug interactions or allergies, or other known condititions are always a major concern in the healthcare community. Treatment errors include but are not limited to: providing the wrong medication or dosage; providing the wrong response to a situation; being unaware of certain medical conditions; and operating in the wrong site.

Healthcare organizations have used colored markers to color code the patient's identification band. These colors can wear off, wash off or smudge, obscuring or losing the information. In addition, if the patient's status changes and markers have been used to color code the identification band, the band must be remade.

What is needed in the art is a method of clearly, easily, obviously, and permanently mark a patient identification bracelet to indicate conditions or treatments.

### SUMMARY OF THE INVENTION

The Patient Status System set forth herein addresses this patient safety need. Patient safety can be increased with the instant communication of the patient's status with a color-coded system that attaches to the patient's identification band. These color coded attachments alert staff to the patient's conditions and to potential problems that may arise from certain treatments. Additionally, color-coding informs care-giving staff as to how to respond to a situation in the event that the patient is not able to inform them verbally or for some reason, such as with requesting narcotics, the patient may not be inherently believable.

In accordance with further aspects of an embodiment, the system that allows healthcare providers to affix a color-coded device to the identification band; the patient's identification band can be modified to communicate important information without being remade. In the event the patient's status changes, the color-coded device can be removed and a new color-coded device affixed to the identification band. Color-coded devices that can be added or removed as the patient's condition warrants, are less costly than those requiring remaking the identification band with each change. Remaking an identification band introduces another opportunity for errors to be made and should be avoided.

In accordance with further aspects of the invention, when the color coded device is in the closed position it resists re-opening. When the device is affixed to the patient's identification band, attempts to remove the device may result in signs of tampering on either the device or the band. When the device is affixed to the band, the device cannot be lost by accident. In the event the code needs to be changed, the healthcare provider can remove the device from the identification band and affix a new color-coded device to the identification band.

In accordance with further aspects of an embodiment, the color coding system can be utilized for both inpatients and outpatients and will give healthcare providers an immediate visual cue to the patient's health status. The Patient Status System adds another dimension of safety in the care of the patient.

As will be readily appreciated from the foregoing summary, the invention provides a ready means for rapid identification, triage, and treatment of patients in need of care.

### BRIEF DESCRIPTION OF THE DRAWINGS

Preferred and alternative embodiments of the present invention are described in detail below with reference to the following drawings.

FIG. 1 is a perspective of one embodiment of a patient Identification (ID) band;

FIG. 2 is a plan view of the patient ID band of FIG. 1;

FIG. 3 is a plan view of one embodiment of a color coded device unit;

FIG. 4 is a section view of the color coded device unit of FIG. 3; and,

FIG. 5 is a side view of the color coded device unit of FIG. 3.

### DETAILED DESCRIPTION OF THE DRAWINGS

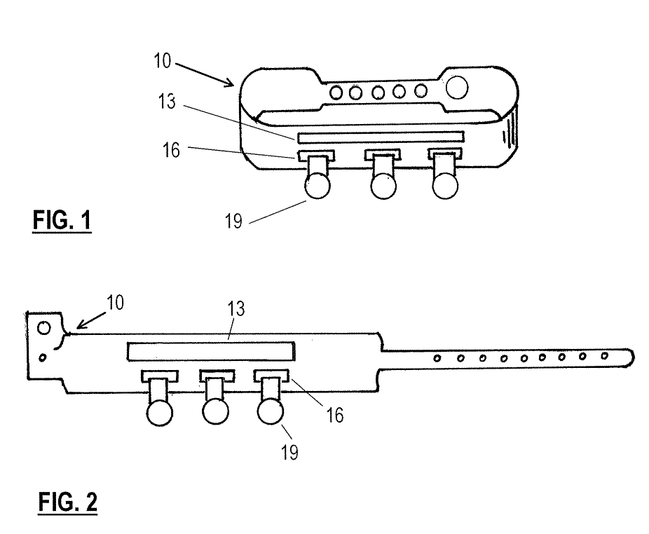

FIG. 1 is a perspective view of one embodiment of a patient Identification (ID) band 10 in the closed position as it would appear on the patient (not shown). Advantageously, the closed position is configured to show a name tag and an optional bar code location 13. Apertures 16 defined in the ID band admit color-coded device units 19 for affixing. The color-coded device units 19 are evident in the closed position affixed to the ID band 10.

FIG. 2 is a plan view of the patient ID band 10 in the open position as it would appear before it is put on the patient. In the open position, the patient ID band 10 shows the name tag and bar code location 13, as well as the apertures 16 in the ID band 10 through which the color-coded device units 19 are affixed.

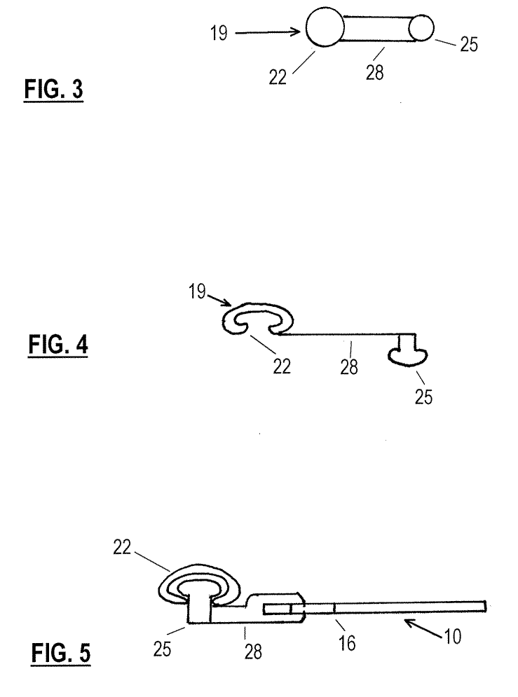

FIG. 3 is a plan view of one embodiment of the color coded device unit 19 in the open position as it would appear before it is affixed to the ID band 10. As shown in the plan view, the ID band 10 is configured to show color-coded first element 22 which itself is configured to receive second element 25. The second element 25 is configured for insertion into the first element 22. A strap 28 holds the first and second elements together as a unit 19, so as to create a loop when affixing the device through the apertures 16 on the ID band 10.

FIG. 4 is a section view of the color-coded device unit 19 of FIG. 3 in the open position. In one nonlimiting example, the first element 22 is configured as a female connector configured to engage the second element 25, a male connector, in positive engagement. In an open position, the color-coded device 19 is configured to appear on the ID Band 10 in a manner to reveal the color-coded first element 22, which itself receives the second element 25 in locking engagement.

The second element 25 includes a protuberance configured for insertion into a corresponding void the first element 22. The strap 28 is configured to flexibly connect the first 22 and second elements 25 as a unit 19. The strap 28 connects in a fashion to serve as a stop preventing the first element 22 from engulfing the second element and further to create a loop when the first 22 and second elements 25 are engaged. In the practice of the invention, the protuberance of the second element is inserted through the at least one aperture 16 (FIG. 1) into the void of the first element 22 to fixedly attach the unit 19 to the band 10.

FIG. 5 is a side view of the color-coded device unit 19 of FIG. 3 in the closed position. In the closed position, the second element 25 engages the first element 22 in locking engagement. The second element 25 engages the first element 22 to attach to the ID band 10 through the aperture 16.

While the preferred embodiment of the invention has been illustrated and described, as noted above, many changes can be made without departing from the spirit and scope of the invention. For example, the second element 25 may engage the first element 22, without requiring that the elements engage to close the ID band 10. The color-coded devices 19 may be a variety of shapes and configurations attachable to the ID band, such as, for example, pegs, snaps, or buttons. The ID band 10 need not include apertures 16, in which case the color-coded devices 19 would be configured to encircle the band 10 instead of being inserted through the aperture 16. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A patient status system comprising:
an identification band;
at least one color-coded device configured to attach to the identification band.

2. The system of claim 1 wherein the identification band is configured to attach to an appendage of a person.

3. The system of claim 1 wherein the identification band defines at least one aperture configured to admit the at least one color-coded device.

4. The system of claim 1 wherein the at least one color-coded device conveys information through visual inspection of the device.

5. The system of claim 1 wherein the at least one color-coded device includes a first element and a second element configured to engage the first element by means of a protuberance, the protuberance configured to pass through the at least one aperture.

6. The system of claim 1 including a second color-coded device, wherein the second color-coded device including a color distinct from the that of the color-coded device, and the second color corresponds to a different quantum of information.

7. The system of claim 1, wherein the at least one color-coded device further comprises:
a first element configured to have a color;
a second element configured to attach to the first element;
a strap connecting the first element to the Second element.

8. The system of claim 7 wherein the identification band includes at least one aperture and the second element is configured to attach to the first element through the at least one aperture.

9. The system of claim 7 wherein the second element includes a protuberance configured for insertion into the first element, and the first element is configured to receive the protuberance of the second element.

10. The system of claim 9, wherein the first element includes configured to lockably engage the second element.

11. The system of claim 10, wherein attempts to detach the second element from the first element result in visual signs of tampering on at least one of the device and the band.

12. The system of claim 8 wherein at least one of the first element and the second element of the at least one device is configured for insertion through the at least one aperture.

13. The system of claim 1, wherein the at least one device may be removed from the band and another device may be attached to the band without producing damage to the band.

14. The system of claim 1, wherein the at least one device is one of a peg, a snap, and a button.

15. A method comprising:
selecting a color-coded device according to a status of a patient; and
affixing the device to a patient identification band.

16. A patient status system comprising:
at least one color-coded device configured to attach to a patient identification band.
